(19) United States
(12) Patent Application Publication
(10) Pub. No.: US 2010/0083353 A1
(43) Pub. Date: Apr. 1, 2010

(54) PERSONALIZED USER AUTHENTICATION PROCESS

(75) Inventor: Tak Yin Wang, Los Altos, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/238,694

(22) Filed: Sep. 26, 2008

(51) Int. Cl. H04L 9/32

(52) U.S. Cl. 726/5

(57) ABSTRACT

A system and method for authenticating a user seeking access to a resource via a computer is described herein. In accordance with one embodiment, a person authorized to control access to the resource selects a personalized combination of non-text elements, a collection of non-text elements from which the combination must be selected, and an arrangement in which the collection of non-text elements is presented to the user. When the user attempts to access the resource, the system presents the collection of non-text elements to the user and requires the user to select a combination of non-text elements from among the collection of non-text elements that matches the personalized combination previously selected by the person authorized to control access to the resource.

### BACKGROUND OF THE INVENTION

1. Field of the Invention

The present invention relates to systems and methods for preventing unauthorized users from accessing a resource via a computer. The present invention also relates to systems and methods for preventing the fraudulent acquisition of sensitive information that may be exploited by unauthorized users to access a resource via a computer.

2. Background

There has been an exponential increase in the number of people using the Internet to conduct financial transactions as well as to engage in professional and social activities. To facilitate these transactions and activities, many people have established online accounts with entities such as banks, brokerage firms, credit card companies, retailers, utilities, social Web sites, auction Web sites, or the like. These online accounts may be used to access private information about the account owner and/or to engage in financial transactions or other activities on behalf of the account owner. Accordingly, such accounts must be secured so that they cannot be accessed by someone other than the account owner.

To this end, administrators of online accounts typically require a user seeking access to an account to submit an identifier (ID) that is uniquely associated with the account owner (sometimes called a user ID) as well as a password or passcode that should be known only to the account owner before providing access. One issue with this approach, however, is that an account owner may be tricked into unwittingly providing the user ID and password/passcode to an unauthorized user through a process known as “phishing.”

In computing, “phishing” refers to the fraudulent process of attempting to acquire sensitive information, such as user IDs, passwords and passcodes, by masquerading as a trustworthy entity in an electronic communication. Communications purporting to be from online banks, social web sites, auction sites, or Information Technology (IT) administrators are commonly used to lure the unsuspecting. Phishing is typically carried out by e-mail or instant messaging, and it often directs account owners to enter details at a fake Web site whose Uniform Resource Locator (URL) and look and feel are almost identical to a legitimate one. Even when using communication protocols having strong cryptography for server authentication it is often difficult to detect that a Web site is fake. Phishing is a rapidly growing problem for both consumers and enterprises.

User authentication protocols built around the submission of user IDs and passwords/passcodes are particularly susceptible to phishing because it is relatively easy to create a legitimate-looking interface for entering such information, which typically consists of strings of characters and/or numbers. To address this issue, some protocols include additional steps that require a user to submit additional passwords or passcodes or that require a user to answer one or more “secret questions,” the answers to which should only be known to the account owner. However, such protocols place an additional burden on account owners by requiring them to keep track of the additional passwords/passcodes or answers. Furthermore, the addition of such steps does not necessarily make phishing any more difficult, since it may still be relatively easy to mimic the interfaces that solicit such additional passwords/passcodes or that ask such “secret questions.”

Another approach taken by account administrators is to have an account owner create or select an image, sometimes referred to as a “sign-in seal,” during account setup or thereafter. Such a sign-in seal may be uniquely associated with the account owner or with a computer used by the account owner. When the account owner subsequently attempts to log into the account, the account administrator will present the sign-in seal. If the account owner is presented with a login interface that does not include the sign-in seal, then the account owner can assume that the interface is a fake one and abort the login attempt.

Although sign-in seals are helpful, they may not prevent an account owner from falling prey to phishing in every instance. For example, account owners may forget that such a sign-in seal is supposed to be presented during the login process or may simply assume that the absence of the sign-in seal during the login process is due to a benign technical issue rather than phishing. Account owners may thus provide their sensitive login information to a phisher despite the absence of a sign-in seal. Furthermore, once a phisher has obtained the necessary login information, the sign-in seal does nothing to prevent them from accessing the account.

Another method for securing online accounts is to use cryptography-based access protocols. However, the use of such protocols typically requires the installation of special software on every computer that will be used to access the account. Furthermore, some cryptography-based protocols, such as RSA SecurID® (developed by RSA Security of Bedford, Mass.), require the account owner to purchase and carry a special token for periodically generating authentication codes needed to log into an account.

What is needed, then, is a system and method for authenticating a user that is seeking to access a resource, such as an online account, that addresses one or more of the shortcomings associated with conventional user authentication systems and methods.

### BRIEF SUMMARY OF THE INVENTION

A system and method for authenticating a user seeking access to a resource via a computer is described herein. In accordance with one embodiment, a person authorized to control access to the resource selects a personalized combination of non-text elements (such as images), a collection of non-text elements from which the combination must be selected, and an arrangement in which the collection of non-text elements is presented to the user. When the user attempts to access the resource, the system presents the collection of non-text elements to the user and requires the user to select a combination of non-text elements from among the collection of non-text elements that matches the personalized combination previously selected by the person authorized to control access to the resource.

Because the user authentication process utilizes non-text elements that are presented in a highly-personalized manner, the system and method aids in combating phishing, since the user interface for implementing the process is difficult to duplicate. Furthermore, the user authentication process may advantageously be tailored to render random guessing of the proper combination of non-text elements highly unlikely while still maintaining ease of use for users. An embodiment of the invention also advantageously notifies the person authorized to control access to the resource if a user seeking access to the resource has exceeded a predefined time limit during an attempt to pass the authentication process, thereby enabling the person to respond to potential phishing or unauthorized access attempts. An embodiment of the invention may also advantageously be combined with other user authentication protocols to provide an additional level of security.

In particular, a method for authenticating a user seeking to access a resource via a computer is described herein. In accordance with the method, a plurality of non-text elements is presented to the user via a user interface of the computer. Each of the plurality of non-text elements is selectable by the user via the user interface. A combination of non-text elements selected by the user from among the plurality of non-text elements is then compared to a combination of non-text elements previously selected by a person authorized to control access to the resource. The user is then granted access to the resource via the computer responsive to a determination that the combination of non-text elements selected by the user matches the combination of non-text elements previously selected by the person authorized to control access to the resource.

Presenting the plurality of non-text elements to the user via the user interface of the computer may include presenting a plurality of unique images to the user via a graphical user interface of the computer. Additionally, the plurality of non-text elements presented to the user may have previously been selected by the person authorized to control access to the resource from a larger plurality of non-text elements. Furthermore, presenting the plurality of non-text elements to the user may include presenting the plurality of non-text elements in accordance with an arrangement previously specified by the person authorized to control access to the resource.

The foregoing method may also include determining an amount of time that has elapsed after presenting the plurality of non-text elements to the user during which the user has not selected a combination of non-text elements and sending a message to the person authorized to control access to the resource if the amount of time exceeds a predefined amount of time.

The presenting, comparing and granting steps of the foregoing method may be performed responsive to determining that the user has successfully completed a first-level user authentication process.

A system for authenticating a user seeking to access a resource via a computer is also described herein. The system includes a database and user authentication logic communicatively connected to the database. The database stores a combination of non-text elements previously selected by a person authorized to control access to the resource. The user authentication logic is configured to present a plurality of non-text elements to the user via a user interface of the computer, each of the plurality of non-text elements being selectable by the user via the user interface, to compare a combination of non-text elements selected by the user from among the plurality of non-text elements to the combination of non-text elements stored in the database, and to grant the user access to the resource via the computer responsive to determining that the combination of non-text elements selected by the user matches the combination of non-text elements stored in the database.

The user authentication logic may be configured to present a plurality of unique images to the user via a graphical user interface of the computer. The system may also include user account setup logic configured to allow the person authorized to control access to the resource to select the plurality of non-text elements to be presented to the user by the user authentication logic from a larger plurality of non-text elements. The user account setup logic may be further configured to allow the person authorized to control access to the resource to specify an arrangement in which the plurality of non-text elements will be presented to the user by the user authorization logic and the user authentication logic may be further configured to present the plurality of non-text elements to the user in accordance with the specified arrangement.

The user authentication logic may be further configured to determine an amount of time that has elapsed after presentation of the plurality of non-text elements to the user during which the user has not selected a combination of non-text elements and to send a message to the person authorized to control access to the resource if the amount of time exceeds a predefined amount of time.

The user authentication logic may comprise second-level user authentication logic and the system may further include first-level user authentication logic configured to execute a first-level user authentication process, wherein the second-level user authorization logic is configured to operate responsive to successful completion of the first-level user authentication process by the user.

A computer program product is also described herein. The computer program product comprises a computer-readable medium having computer program logic recorded thereon for enabling a processing unit to authenticate a user seeking to access a resource via a computer. The computer program logic includes first means, second means and third means. The first means is for enabling the processing unit to present a plurality of non-text elements to the user via a user interface of the computer, each of the plurality of non-text elements being selectable by the user via the user interface. The second means is for enabling the processing unit to compare a combination of non-text elements selected by the user from among the plurality of non-text elements to a combination of non-text elements previously selected by a person authorized to control access to the resource. The third means is for enabling the processing unit to grant the user access to the resource via the computer responsive to determining that the combination of non-text elements selected by the user matches the combination of non-text elements previously selected by the person authorized to control access to the resource.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example system in which a personalized user authentication process in accordance with an embodiment of the present invention may be implemented.

FIG. 2 depicts a flowchart of a process by which an account owner may select a personalized combination of images for use in a user authentication process in accordance with an embodiment of the present invention.

FIG. 3 illustrates a graphical user interface (GUI) displaying a plurality of images from which a personalized combination of images must be selected as part of a user authentication process in accordance with an embodiment of the present invention.

FIGS. 4 and 5 each illustrate a GUI that displays the same plurality of images depicted in FIG. 3 in accordance with a new arrangement specified by an account owner in accordance with an embodiment of the present invention.

FIG. 6 illustrates a personalized combination of images that must be selected as part of a user authentication process in accordance with an embodiment of the present invention.

FIGS. 7, 8 and 9 respectively depict a first flowchart, a second flowchart and a third flowchart that, taken together, represent a two-level process for authenticating a user seeking to access a resource in accordance with an embodiment of the present invention.

FIG. 10 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

A system and method is described herein for authenticating a user seeking access to a resource. In accordance with one embodiment, a person authorized to control access to the resource selects a personalized combination of non-text elements (such as images), a collection of non-text elements from which the combination must be selected, and an arrangement in which the collection of non-text elements is presented to the user. When the user attempts to access the resource, the system presents the collection of non-text elements to the user and requires the user to select a combination of non-text elements from among the collection of non-text elements that matches the personalized combination previously selected by the person authorized to control access to the resource.

Because the user authentication process utilizes non-text elements that are presented in a highly-personalized manner, the system and method aids in combating phishing, since the user interface for implementing the process is difficult to duplicate. For example, in one embodiment described herein, an account owner selects a collection of 20 images from among 200 available images for presentation to a user during the user authentication process, which equates to C₂₀²⁰⁰ or 1.61e+27 different combinations that may be presented to the user. The placement and organization of such images when presented to the user may also be personalized. This makes it extremely difficult for a phisher to set up a generic user interface for phishing.

Furthermore, the user authentication process may advantageously be tailored to render random guessing of the proper combination of non-text elements highly unlikely while still maintaining ease of use for users. In one embodiment described herein, an account owner must select and remember only 3 images out of a collection of 20 images to serve as a personal combination for passing the user authentication process. In such an embodiment, the probability that a phisher could randomly guess the correct combination would be 1 in C₃²⁰, or 1 in 1140, which equates to a less than 0.1% chance of success. In an alternative embodiment, it is possible to have 6 columns of images with each column containing the same 10 user-selected images forming a personalized combination lock that is similar to a 6-digit combination lock to reduce the probability from 1 in 1140 to 1 in 1,000,000 with some trade-offs in usability. As a further example, if each of the 6 columns contained 10 different user-selected images, then the probability of randomly guessing a correct 6-image combination would be reduced to C₆⁶⁰, or 1 in 50,063,860.

An embodiment of the invention further enhances usability by not requiring the person authorized to control access to the resource to remember additional passwords, passcodes, or answers to “secret questions.” Still further, an embodiment of the invention can work on virtually any computer without requiring such person to purchase and carry a special token or to install special software.

An embodiment of the invention also advantageously provides a self-protection mechanism. In particular, an embodiment of the invention notifies the person authorized to control access to the resource if a user seeking access to the resource has exceeded a predefined time limit during any attempt to pass the authentication process, thereby enabling the person to respond to potential phishing or unauthorized access attempts. Furthermore, in an embodiment described herein, the relevant resource is locked such that any computer-based access to the resource is prohibited if a maximum number of failed attempts to pass the authentication process is exceeded.

An embodiment of the invention may also advantageously be combined with other user authentication protocols to provide an additional level of security. For example, an embodiment of the invention may be combined with a typical user authentication protocol that requires a user to provide a user ID and password in order to access a resource. In addition, an embodiment of the present invention may be used in combination with a sign-in seal or other method for enhancing security.

### B. Example Operating Environment

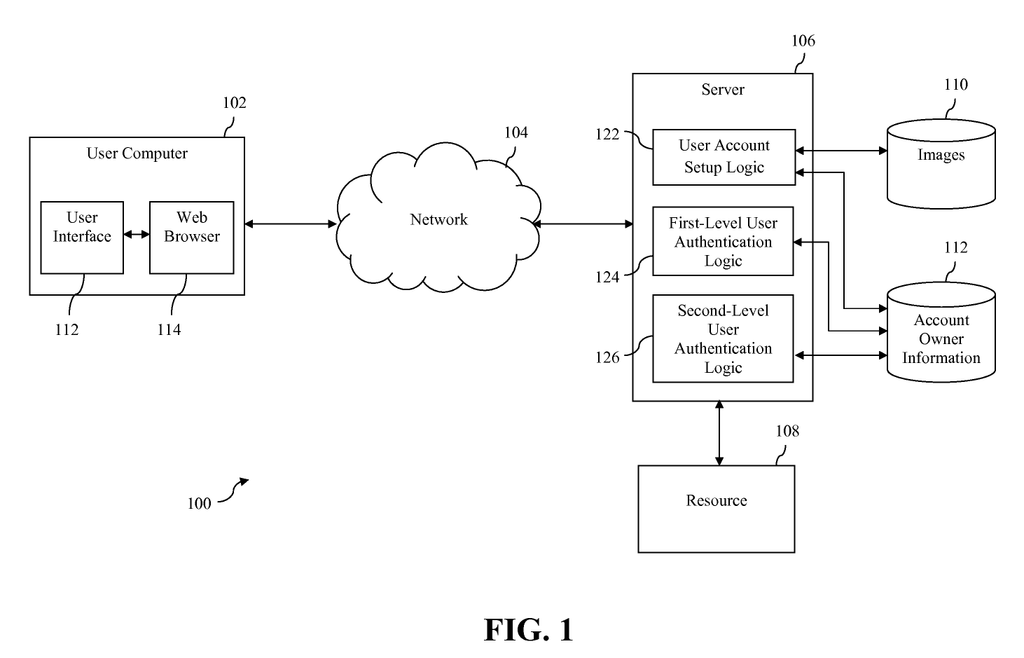

FIG. 1 is a block diagram of an example system 100 in which a personalized user authentication process in accordance with an embodiment of the present invention may be implemented. As shown in FIG. 1, system 100 includes a user computer 102 that is communicatively connected to a server 106 via a network 104. Server 106 is further connected to a resource 108. Generally speaking, system 100 is configured to provide access to resource 108 to a user of computer 102 provided that the user successfully completes first-level and second-level user authentication processes implemented by server 106.

Resource 108 is intended to broadly represent any logical or physical entity that can be accessed by a computer. For the remainder of this description, it will be assumed that resource 108 comprises a collection of information or a service that is available to an owner of an online account, although this example is not intended to be limiting and other types of resources may be secured in accordance with the present invention. The online account may be, for example, an online bank account, brokerage account, credit card account, retail account, utility account, e-mail account, social Web site account, auction Web site account, or the like.

User computer 102 comprises any processor-based system or device that can be used to access resource 108. For example, user computer 102 may comprise a desktop computer, laptop computer, tablet computer, gaming console, personal digital assistant (PDA), media player, or cellular telephone, although these examples are not intended to be limiting.

As shown in FIG. 1, user computer 102 includes a number of interconnected components including a user interface 112 and a Web browser 114. User interface 112 comprises one or more components configured to accept input from a user, such as, for example, a keyboard, keypad, mouse and/or touch-sensitive display screen. User interface 112 further comprises one or more components configured to provide output to the user, such as, for example, a display screen and/or one or more audio speakers. Web browser 114 comprises a software application that enables a user to access information and services available via network 104.

In one embodiment, network 104 comprises the Internet. However, the invention is not so limited, and network 104 may comprise any type of network or combination of networks including wide area networks, local area networks, private networks, public networks, packet networks, circuit-switched networks, and wired or wireless networks.

Server 106 comprises a computer configured to provide one or more services to other computers, such as user computer 102, over network 104. In particular, server 106 is configured to perform a two-level user authentication process that will be described in more detail herein to determine if a user of user computer 102 should be granted access to resource 108. As shown in FIG. 1, server 106 includes a number of interconnected components including user account setup logic 122, first-level user authentication logic 124, and second-level user authentication logic 126.

User account setup logic 122 includes logic that is configured to allow an account owner or other person authorized to control access to resource 108 to specify information that must be provided by a user during a first-level user authentication process. Such information may include, for example, a unique user identifier (ID) and a password, although this example is not intended to be limiting. Such information specified by the account owner is stored in an account owner information database 112 that is accessible to server 106.

User account setup logic 122 also includes logic that is configured to allow the account owner associated with resource 108 to select a personalized combination of images that must be selected by a user from among a plurality of images during a second-level user authentication process. User account setup logic 122 may further include logic that is configured to allow the account owner to select a larger collection of images from which the personalized combination of images must be selected during the second-level user authentication process. User account setup logic 122 may still further include logic that is configured to allow the account owner to specify an arrangement for presenting such a collection of images to the user. The combination of images as well as the larger collection of images may each be selected from a plurality of images that are stored in a database 110 that is accessible to server 106. An identification of the images selected by the account owner as well as any preferences regarding how such images should be presented during the second-level user authentication process is stored in account owner information database 112.

First-level user authentication logic 124 is configured to perform a first-level process for authenticating a user of user computer 102 that is seeking to access resource 108. In an embodiment, performing this process includes presenting an interface, such as a login page, to the user via a display of user computer 102, wherein the interface can be used by the user to input a user ID and a password. If the user inputs a user ID and password that matches a user ID and password previously specified by the account owner and stored in account owner information database 112, then the user has successfully passed the first-level user authentication process and a second-level user authentication process implemented by second-level user authentication logic 126 is initiated. If, however, the user inputs a user ID or password that does not match the user ID or password previously specified by the account owner, the user has failed the first-level user authentication process and cannot proceed to the second-level user authentication process.

Second-level user authentication logic 126 is configured to perform a second-level process for authenticating a user of user computer 102 that is seeking to access resource 108. In an embodiment, performing this process includes presenting the user with a plurality of images via user interface 112 of user computer 102 and requiring the user to select a combination of images from among the plurality of images. If the user selects a combination of images that matches a combination of images previously specified by the account owner and identified in account owner information database 112, then the user has successfully passed the second-level user authentication process and is granted access to resource 108. If, however, the user fails to select a matching combination of images, then the user will not be granted access to resource 108.

As will be described in more detail herein, second-level user authentication logic 126 may be configured to allocate more than one opportunity to a user to select the correct combination of images. However, second-level user authentication logic 126 may also be configured to lock resource 108 to access by any user via any user computer if a maximum number of failed attempts is exceeded.

As will also be described in more detail herein, second-level user authentication logic 126 may also be configured to monitor an amount of time that has elapsed after presenting the plurality of images to the user during which no combination has been selected. If the amount of time exceeds a predefined time limit, a warning message may be sent to the account owner. This monitoring routine may be performed during each second-level user authentication attempt granted to the user.

Detailed examples of certain processes managed by user account setup logic 122, first-level user authentication logic 124 and second-level user authentication logic 126 will now be described.

### C. Second-Level User Authentication Setup in Accordance with an Embodiment of the Present Invention

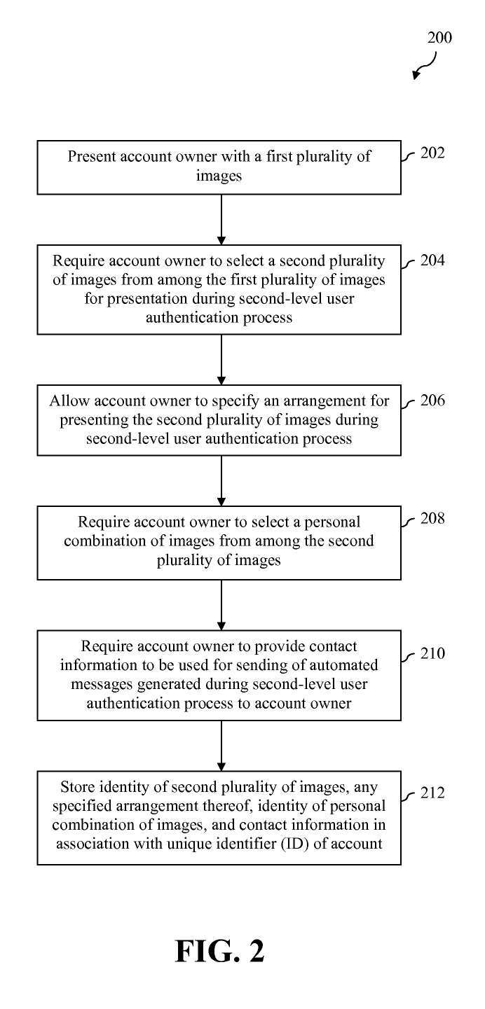

As noted above, user account setup logic 122 is configured to allow an account owner associated with resource 108 to select a personalized combination of images that must be selected by a user from among a plurality of images during a second-level user authentication process. An example process by which the account owner may select the personalized combination of images as well as specify or configure other aspects of the second-level user authentication process will now be described in reference to flowchart 200 of FIG. 2. Although the method of flowchart 200 will now be described with continued reference to system 100 of FIG. 1, the method is not limited to that implementation.

For the purposes of this description, it is assumed that the account owner is using a computer that is similar to user computer 102 of FIG. 1 to access server 106 via network 104.

As shown in FIG. 2, the method of flowchart 200 begins at step 202 in which user account setup logic 122 presents the account owner with a first plurality of images obtained from images database 110. In an embodiment, the first plurality of images is presented to a graphical user interface (GUI) of the computer being used by the account owner. The number of images in the first plurality of images may be relatively large. For example, there may be 200 images in the first plurality of images, although this is only an example. To facilitate the presentation, subsets of such images may be presented serially to the GUI. Each image in the first plurality of images may be different or unique with respect to the other images in the first plurality of images.

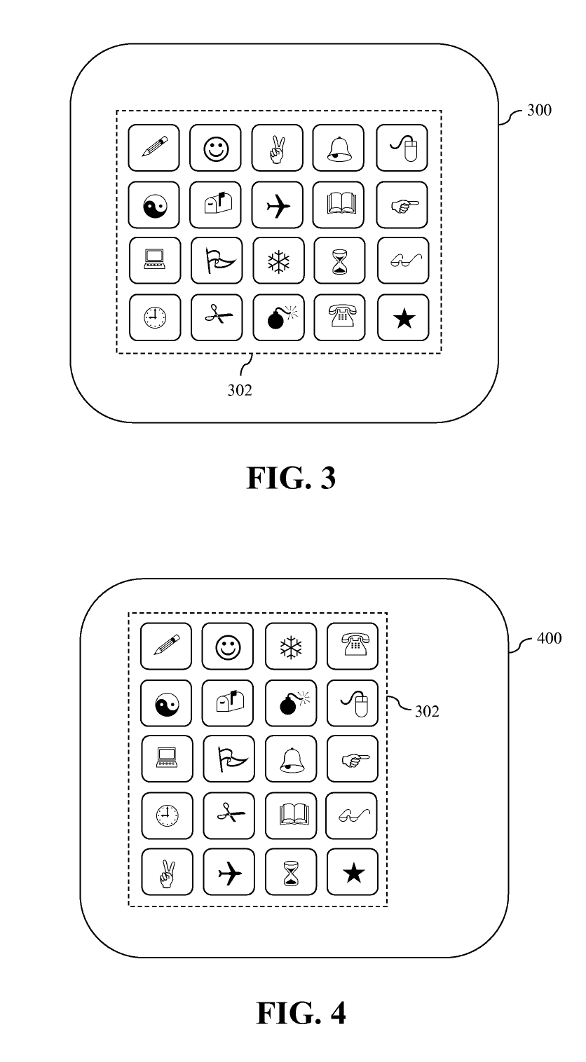

At step 204, user account setup logic 122 requires the account owner to select a second plurality of images from among the first plurality of images for presentation to a user during a second-level user authentication process. The number of images in the second plurality of images is preferably smaller than the number of images in the first plurality of non-text elements. In one embodiment, the user is required to select 20 images from among a collection of 200 images. Such an embodiment requires the user to select one out of C₂₀²⁰⁰ different combinations, or one out of 1.61e+27 different combinations. However, this is only one example and other numbers may be used. FIG. 3 depicts a GUI 300 that displays an example second plurality of images 302 that may be selected by the account owner in accordance with step 204.

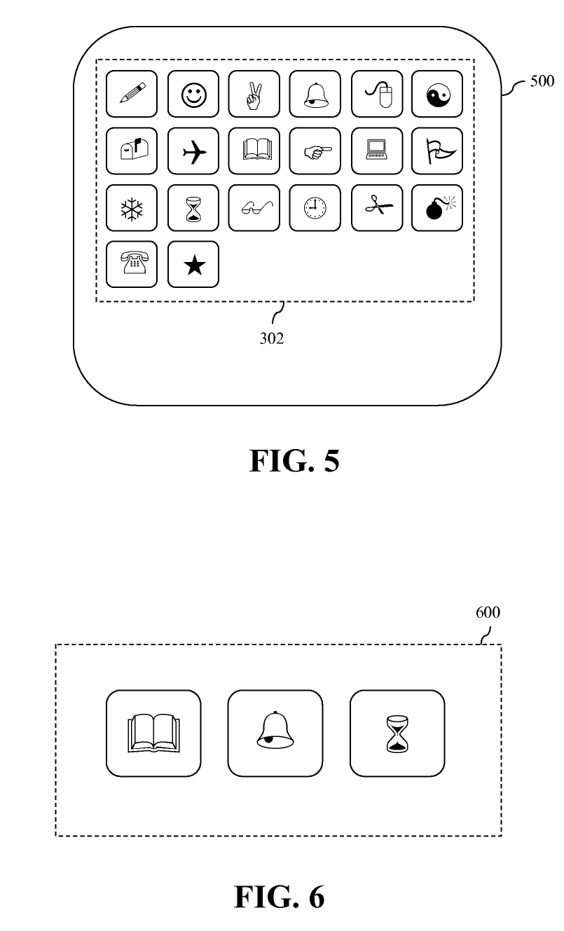

At step 206, user account setup logic 122 allows the account owner to specify an arrangement for presenting the second plurality of images to a user during the second-level user authentication process. Depending upon the implementation, this step may include allowing the user to specify where certain images within the second plurality of images should be displayed relative to other images (or relative to other elements of a GUI to be presented to the user) and/or to specify a number of rows and or columns into which the images should be organized. For example, FIG. 4 depicts a GUI 400 in which the second plurality of images 302 depicted in FIG. 3 has been reorganized by the account owner from the 4 row by 5 column arrangement to a 5 row by 4 column arrangement. As another example, FIG. 5 depicts a GUI 500 in which the second plurality of images 302 depicted in FIG. 3 has been reorganized by the account owner into an arrangement of 3 rows consisting of 6 images each and a fourth row consisting of only 2 images. However, these are only examples, and other methods for personalizing the layout and organization of the images in the second plurality of images may be used.

At step 208, user account setup logic 122 requires the account owner to select a personal combination of images from among the second plurality of images selected in step 204. The personal combination of images selected by the account owner must be selected by a user in order to pass the second-level user authentication process. In one embodiment, this step comprises requiring the account owner to select 3 images from among 20 images. In such an embodiment, the probability of a user randomly guessing the correct combination of images is 1 in C₃²⁰, or 1 in 1140, which equates to a less than 0.1% chance of success. However this is only one example and other numbers may be used. FIG. 6 depicts an example of a personal combination 600 of 3 images selected by an account owner from among the second plurality of images 302 depicted in FIG. 3.

At step 210, user account setup logic 122 requires the account owner to provide contact information that can be used to send automated messages to the account owner that may be generated during the second-level user authentication process. Such contact information may include, for example, a telephone number, e-mail address, or user ID. Such contact information may be used to contact the account owner through such means as an automated telephone call, e-mail message, text message, instant message or the like. The account owner may be encouraged to provide contact information that can be used to deliver automated messages to a mobile device customarily carried with the account owner, such as a cellular telephone or pager, so that the account owner will be likely to receive the messages in a timely manner.

At step 212, the identity of the second plurality of images selected during step 204, any arrangement thereof specified during step 206, the identity of the personal combination of images selected during step 208 and the contact information provided in step 210 are all stored in account owner information database 112 for subsequent use during the second-level user authentication process. Such information may be stored in association a unique identifier (ID) of the account owner, which may be for example a user ID, e-mail address, or the like, depending upon the implementation.

The foregoing method may further include the additional step of requiring the account owner to acknowledge that after a predetermined number of failed attempts to pass the second-level user authentication process, resource 108 will be locked to any computer-based access until the account owner re-enables access through a specified protocol. In an embodiment to be described in more detail herein, resource 108 is locked after there have been two failed attempts to pass the second-level user authentication process. However, this is only an example, and locking of resource 108 may occur after any numbers of failed attempts depending upon the implementation.

### D. Two-Level User Authentication Process in Accordance with an Embodiment of the Present Invention

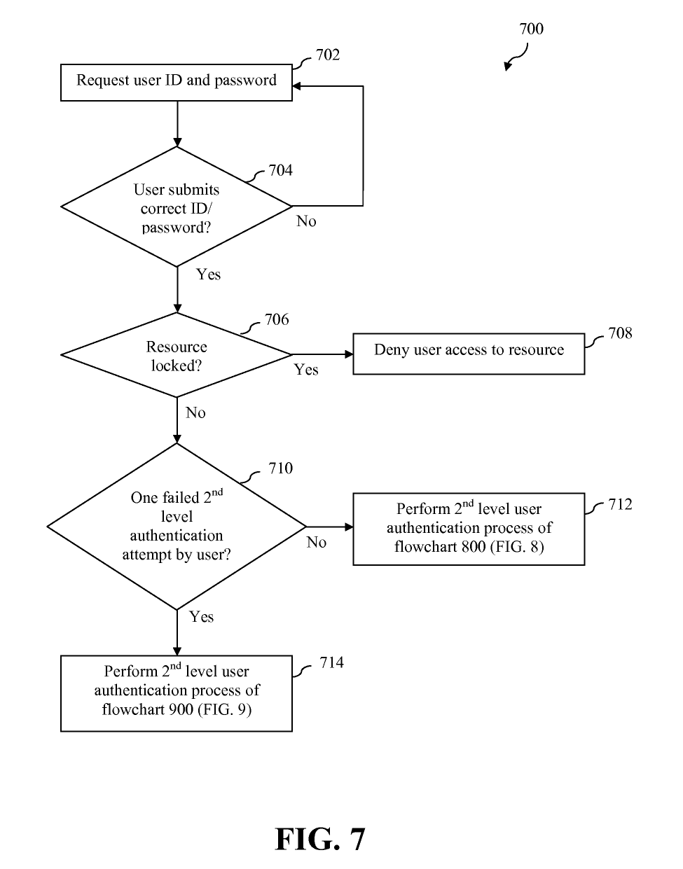

FIGS. 7, 8 and 9 respectively depict a flowchart 700, a flowchart 800 and a flowchart 900 that, taken together, represent a two-level process for authenticating a user seeking to access a resource in accordance with an embodiment of the present invention. The process represented by these flowcharts will now be described with continued reference to system 100 of FIG. 1. However, the method is not limited to that implementation.

As shown in FIG. 7, the process begins at step 702 in which first-level user authentication logic 124 initiates a first level of user authentication by requesting a user ID and password from a user of user computer 102. First-level user authentication logic 124 may perform this step, for example, by presenting an interface, such as a login page, to a display of user computer 102, wherein the interface can be used by the user to input the requested user ID and password.

At decision step 704, first-level user authentication logic 124 determines if the user has submitted a user ID and password that matches a user ID and password previously specified by the account owner and stored in account owner information database 112. If first-level user authentication logic 124 determines that the user has not submitted a matching user ID and password, then first-level user authentication logic 124 does not allow the user to proceed to the second level of user authentication. Instead, the user can only continue to attempt to submit the correct user ID and password as shown by the arrow returning from decision step 704 to step 702.

If, however, first-level user authentication logic 124 determines that the user has submitted a user ID and password that matches the user ID and password previously specified by the account owner, then the user has passed the first-level user authentication process. Responsive to the user passing the first-level user authentication process, first-level user authentication logic 124 determines whether or not resource 108, which is associated with the authenticated user ID, is currently locked as shown at decision step 706. As will be described in more detail herein, a resource may be locked if a maximum number of failed attempts at passing the second-level user authentication process has been exceeded.

If first-level user authentication logic 124 determines that resource 108 is locked, then first-level user authentication logic 124 denies the user access to resource 108 as shown at step 708. First-level user authentication logic 124 may also prompt the user to engage in a certain protocol for re-enabling access to the resource. This protocol may entail, for example, contacting a technical support representative of an entity that manages resource 108 and/or participating in a different and possibly more intensive user authentication process. As part of re-enabling access to resource 108, the user may also be required to specify a new password to be used in the first-level user authentication process and/or select a new combination of images and/or a new collection of images from which the combination of images should be selected for the second-level user authentication process.

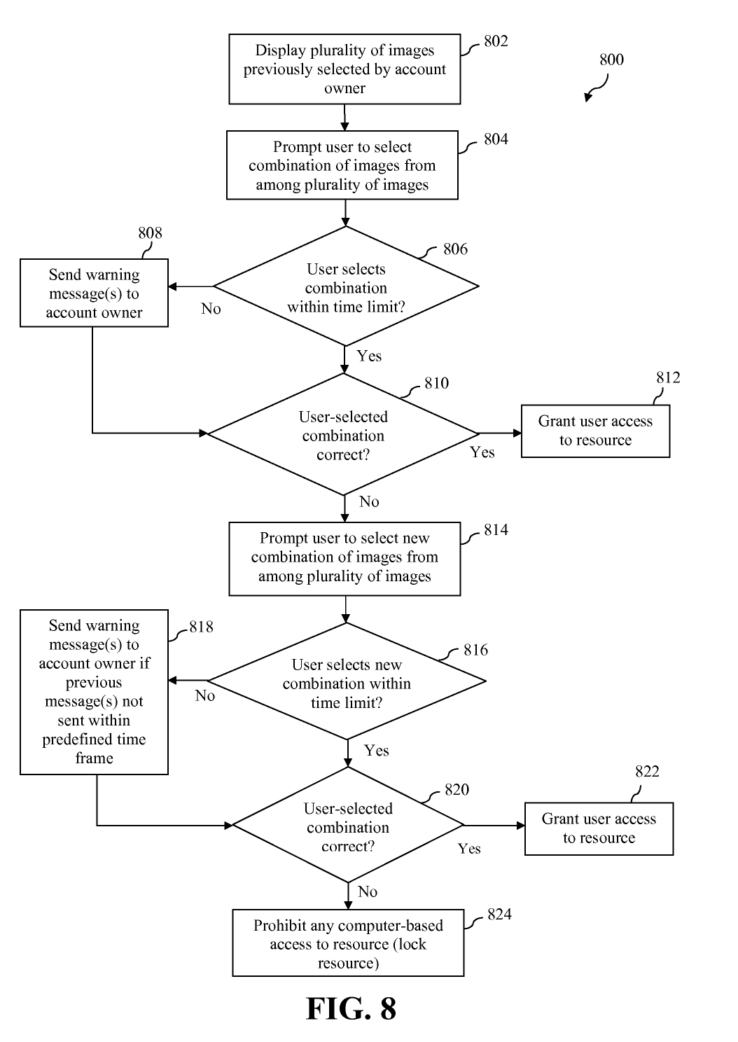

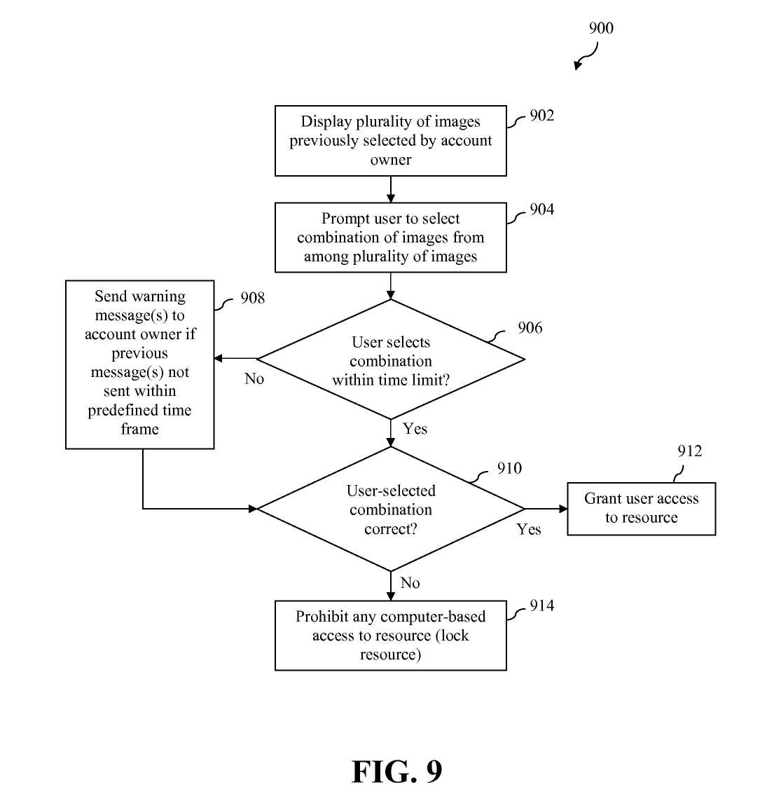

If first-level user authentication logic 124 determines that resource 108 is not locked, then first-level user authentication logic 124 determines if there has been one previous failed attempt by a user associated with the authenticated user ID to pass the second-level user authentication process as shown at decision step 710. If there have been no such previous failed attempts, then a second-level user authentication process depicted in flowchart 800 of FIG. 8 is performed as shown at step 712. If there has been one such previous failed attempt, then an abbreviated second-level user authentication process depicted in flowchart 900 of FIG. 9 is performed as shown at step 714. A scenario in which there have been two or more previous failed attempts by a user associated with the authenticated user ID is not accounted for in this decision step since, in the implementation being described, that would have resulted in locking of resource 108, which was dealt with in previous decision step 710.

The second-level user authentication process depicted by flowchart 800 of FIG. 8 will now be described. It is to be understood throughout this description that a user may abandon the second-level user authentication process at any time. However, if the user does so, then the user will have to complete the first-level user authentication process over again in order to re-initiate the second-level user authentication process.

As shown in FIG. 8, the process of flowchart 800 begins at step 802 in which second-level user authentication logic 126 presents a plurality of images to the user of user computer 102, wherein the plurality of images presented was previously selected by the account owner associated with resource 108. Second-level user authentication logic 126 determines which images to present by accessing information associated with the account owner (who has been identified by virtue of the successful completion of the first-level user authentication process) in account owner information database 112. One manner by which the account owner may have selected the plurality of images was described above in reference to steps 202 and 204 of flowchart 200.

Presenting the plurality of images to the user in step 802 may comprise presenting the plurality of images to a GUI of user computer 102. Presenting the plurality of images to the user may also include presenting the plurality of images in accordance with an arrangement previously specified by the account owner. The arrangement may be specified as part of information associated with the account owner in account owner information database 112. One manner by which the account owner may have specified such an arrangement was described above in reference to step 206 of flowchart 200.

At step 804, second-level user authentication logic 126 prompts the user to select a combination of images from among the plurality of images displayed in step 802. In one embodiment, this step entails prompting the user to select a combination of 3 images from among 20 displayed images, although this is only an example. Selecting an image may comprise using an input device to click on or otherwise interact with an image presented within a display, wherein the input device and the display are each components within user interface 112 of user computer 102.

At decision step 806, second-level user authentication logic 126 determines if the user has selected a combination of images within a first predefined time limit, which in one embodiment comprises 90 seconds. Second-level user authentication logic 126 may perform this step by determining an amount of time that has elapsed after presenting the plurality of images to the user during which the user has not selected a combination of images and comparing the determined amount of time to the first predefined time limit.

If second-level user authentication logic 126 determines that the user has not selected a combination of images within the first predefined time limit, then second-level user authentication logic 126 sends one or more warning messages to the account owner as shown at step 808. The warning message(s) may comprise for example an automated telephone call, e-mail message, text message, instant message, or the like. To send the message(s), second-level user authentication logic 126 may access contact information that was provided by the account owner and stored in account owner information database 112. As previously noted, such contact information may include, for example, a telephone number, e-mail address, user ID, or the like. In one embodiment, a warning message is sent to a mobile device customarily carried with the account owner, such as a cellular telephone or pager, so that the account owner will be likely to receive the message in a timely manner.

If second-level user authentication logic 126 determines that the user has selected a combination of images within the first predefined time limit, or if the user selects the combination of images after the first predefined time limit has elapsed, then second-level user authentication logic 126 compares the combination of images selected by the user to a combination of images previously selected by the account owner as shown at decision step 810. An identification of the combination of images selected by the account owner is available to second-level user authentication logic 126 in account owner information database 112. One manner by which the account owner may have selected the combination of images was described above in reference to step 208 of flowchart 200. If second-level user authentication logic 126 determines that the combination of images selected by the user matches the combination of images previously selected by the account owner, then second-level user authentication logic 126 provides the user with access to resource 108 as shown at step 812.

However, if second-level user authentication logic 126 determines that the combination of images selected by the user does not match the combination of images previously selected by the account owner, then second-level user authentication logic 126 prompts the user to select a new combination of images from among the plurality of images presented to the user as shown at step 814. The user is thus afforded a second opportunity to select the correct combination of images.

At decision step 816, second-level user authentication logic 126 determines if the user has selected a new combination of images within a second predefined time limit, which in one embodiment comprises 90 seconds. Second-level user authentication logic 126 may perform this step by determining an amount of time that has elapsed after prompting the user to select a new combination of images during which the user has not selected a new combination of images and comparing the determined amount of time to the second predefined time limit.

If second-level user authentication logic 126 determines that the user has not selected a new combination of images within the second predefined time limit, then second-level user authentication logic 126 sends one or more warning messages to the account owner provided that one or more previous warning messages have not been sent to the account owner within a predefined time frame as shown at step 818. In one embodiment, the predefined time frame is 3 minutes, although that is only one example. As previously described, the warning message(s) may comprise for example an automated telephone call, e-mail message, text message, instant message, or the like.

If second-level user authentication logic 126 determines that the user has selected a new combination of images within the second predefined time limit, or if the user selects the combination of images after the second predefined time limit has elapsed, then second-level user authentication logic 126 compares the new combination of images selected by the user to the combination of images previously selected by the account owner as shown at decision step 820. If second-level user authentication logic 126 determines that the new combination of images selected by the user matches the combination of images previously selected by the account owner, then second-level user authentication logic 126 provides the user with access to resource 108 as shown at step 822. This step may also comprise resetting a counter that tracks the failed number of second level user authentication attempts to zero.

However, if second-level user authentication logic 126 determines that the new combination of images selected by the user also does not match the combination of images previously selected by the account owner, then second-level user authentication logic 126 locks resource 108 to any computer-based access. This step may also include prompting the user to engage in a certain protocol for re-enabling access to the resource as discussed above in reference to step 708 of flowchart 700.

The abbreviated second-level user authentication process depicted by flowchart 900 of FIG. 9 will now be described. As noted above, this process is performed if a user passes the first-level user authentication process but there has already been one failed attempt by a user associated with the authenticated user ID to pass the second-level user authentication process. It is to be understood throughout this description that a user may abandon the second-level user authentication process at any time. However, if the user does so, then the user will have to complete the first-level user authentication process over again in order to re-initiate the second-level user authentication process.

As shown in FIG. 9, the process of flowchart 900 begins at step 902 in which second-level user authentication logic 126 presents a plurality of images to the user of user computer 102, wherein the plurality of images presented was previously selected by the account owner associated with resource 108. Presenting the plurality of images to the user in step 902 may comprise presenting the plurality of images to a GUI of user computer 102. Presenting the plurality of images to the user may also include presenting the plurality of images in accordance with an arrangement previously specified by the account owner.

At step 904, second-level user authentication logic 126 prompts the user to select a combination of images from among the plurality of images displayed in step 902. In one embodiment, this step entails prompting the user to select a combination of 3 images from among 20 displayed images, although this is only an example.

At decision step 906, second-level user authentication logic 126 determines if the user has selected a combination of images within a predefined time limit, which in one embodiment comprises 90 seconds. Second-level user authentication logic 126 may perform this step by determining an amount of time that has elapsed after presenting the plurality of images to the user during which the user has not selected a combination of images and comparing the determined amount of time to the first predefined time limit.

If second-level user authentication logic 126 determines that the user has not selected a combination of images within the predefined time limit, then second-level user authentication logic 126 sends one or more warning messages to the account owner provided that one or more previous warning messages have not been sent to the account owner within a predefined time frame as shown at step 908. In one embodiment, the predefined time frame is 3 minutes, although that is only one example. As previously described, such warning message(s) may comprise for example an automated telephone call, e-mail message, text message, instant message, or the like.

If second-level user authentication logic 126 determines that the user has selected a combination of images within the predefined time limit, or if the user selects the combination of images after the predefined time limit has elapsed, then second-level user authentication logic 126 compares the combination of images selected by the user to a combination of images previously selected by the account owner as shown at decision step 910. If second-level user authentication logic 126 determines that the combination of images selected by the user matches the combination of images previously selected by the account owner, then second-level user authentication logic 126 provides the user with access to resource 108 as shown at step 912. This step may also comprise resetting a counter that tracks the failed number of second level user authentication attempts to zero.

However, if second-level user authentication logic 126 determines that the combination of images selected by the user does not match the combination of images previously selected by the account owner, then second-level user authentication logic 126 locks resource 108 to any computer-based access. This step may also include prompting the user to engage in a certain protocol for re-enabling access to the resource as discussed above in reference to step 708 of flowchart 700.

### E. Alternative Implementations

Although the second-level user authentication process described above requires a user to select a combination of images from among a plurality of images, the present invention may also be implemented using non-text elements other than images. For example, in one implementation, the user may be required to select a combination of audio elements, such as audio tones or sound clips, from among a plurality of audio elements. This type of implementation may be particularly useful for authenticating visually impaired persons or for performing user authentication in an environment or context in which there is no access to a display screen. As another example the user may be required to select a combination of video clips from among a plurality of video clips.

Furthermore, the operating environment described above in reference to system 100 of FIG. 1 is a network-based client-server environment. However, the present invention is not limited to client-server implementations. For example, the various client and server elements of the present invention may be implemented in a single device. Such an implementation is particularly desirable where the single device provides access to secured resources yet is available to a plurality of users. Examples of such devices include Automated Teller Machines (ATMs), certain public workstations, or the like.

### F. Example Processor-Based Implementation

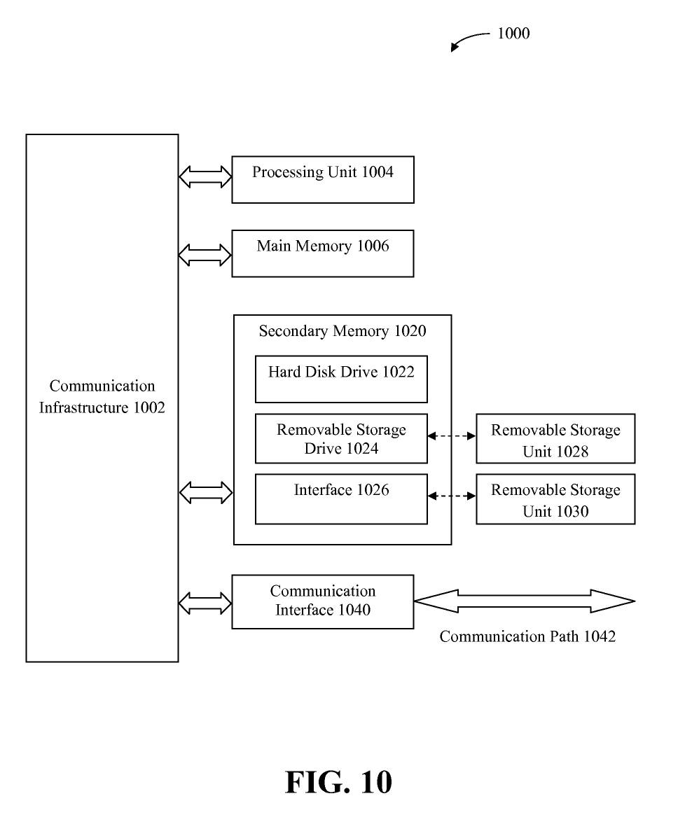

User computer 102 and server 106 shown in FIG. 1 as well as certain steps of flowcharts 200, 700, 800 and 900 respectively depicted in FIGS. 2, 7, 8 and 9 may be implemented by one or more processor-based devices or systems. An example of such a system 1000 is depicted in FIG. 10.

As shown in FIG. 10, system 1000 includes a processing unit 1004 that includes one or more processors. Processor unit 1004 is connected to a communication infrastructure 1002, which may comprise, for example, a bus or a network.

System 1000 also includes a main memory 1006, preferably random access memory (RAM), and may also include a secondary memory 1020. Secondary memory 1020 may include, for example, a hard disk drive 1022, a removable storage drive 1024, and/or a memory stick. Removable storage drive 1024 may comprise a floppy disk drive, a magnetic tape drive, an optical disk drive, a flash memory, or the like. Removable storage drive 1024 reads from and/or writes to a removable storage unit 1028 in a well-known manner. Removable storage unit 1028 may comprise a floppy disk, magnetic tape, optical disk, or the like, which is read by and written to by removable storage drive 1024. As will be appreciated by persons skilled in the relevant art(s), removable storage unit 1028 includes a computer usable storage medium having stored therein computer software and/or data.

In alternative implementations, secondary memory 1020 may include other similar means for allowing computer programs or other instructions to be loaded into system 1000. Such means may include, for example, a removable storage unit 1030 and an interface 1026. Examples of such means may include a program cartridge and cartridge interface (such as that found in video game devices), a removable memory chip (such as an EPROM, or PROM) and associated socket, and other removable storage units 1030 and interfaces 1026 which allow software and data to be transferred from removable storage unit 1030 to system 1000.

System 1000 may also include a communication interface 1040. Communication interface 1040 allows software and data to be transferred between system 1000 and external devices. Examples of communication interface 1040 may include a modem, a network interface (such as an Ethernet card), a communications port, a PCMCIA slot and card, or the like. Software and data transferred via communication interface 1040 are in the form of signals which may be electronic, electromagnetic, optical, or other signals capable of being received by communication interface 1040. These signals are provided to communication interface 1040 via a communication path 1042. Communications path 1042 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1028, removable storage unit 1030 and a hard disk installed in hard disk drive 1022. Computer program medium and computer readable medium can also refer to memories, such as main memory 1006 and secondary memory 1020, which can be semiconductor devices (e.g., DRAMs, etc.). These computer program products are means for providing software to system 1000.

Computer programs (also called computer control logic, programming logic, or logic) are stored in main memory 1006 and/or secondary memory 1020. Computer programs may also be received via communication interface 1040. Such computer programs, when executed, enable system 1000 to implement features of the present invention as discussed herein. Accordingly, such computer programs represent controllers of the computer system 1000. Where an aspect of the invention is implemented using software, the software may be stored in a computer program product and loaded into system 1000 using removable storage drive 1024, interface 1026, or communication interface 1040.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for authenticating a user seeking to access a resource via a computer, comprising:
presenting a plurality of non-text elements to the user via a user interface of the computer, each of the plurality of non-text elements being selectable by the user via the user interface;
comparing a combination of non-text elements selected by the user from among the plurality of non-text elements to a combination of non-text elements previously selected by a person authorized to control access to the resource; and
granting the user access to the resource via the computer responsive to determining that the combination of non-text elements selected by the user matches the combination of non-text elements previously selected by the person authorized to control access to the resource.

2. The method of claim 1, wherein presenting the plurality of non-text elements to the user via the user interface of the computer comprises presenting a plurality of unique images to the user via a graphical user interface of the computer.

3. The method of claim 1, further comprising:
determining an amount of time that has elapsed after presenting the plurality of non-text elements to the user during which the user has not selected a combination of non-text elements; and
sending a message to the person authorized to control access to the resource if the amount of time exceeds a predefined amount of time.

4. The method of claim 3, wherein sending the message to the person authorized to control access to the resource comprises:
sending the message to a mobile device associated with the person authorized to control access to the resource.

5. The method of claim 1, further comprising:
denying the user access to the resource responsive to determining that the combination of non-text elements selected by the user does not match the combination of non-text elements previously selected by the person authorized to control access to the resource.

6. The method of claim 1, further comprising:
prohibiting any computer-based access to the resource responsive to determining that the combination of non-text elements selected by the user is the second of two combinations of non-text elements selected by the user from among the plurality of non-text elements, each of which does not match the combination of non-text elements previously selected by the person authorized to control access to the resource.

7. The method of claim 1, wherein the presenting, comparing and granting steps are performed responsive to determining that the user has successfully completed a first-level user authentication process.

8. The method of claim 1, wherein the plurality of non-text elements presented to the user was previously selected by the person authorized to control access to the resource from a larger plurality of non-text elements.

9. The method of claim 1, wherein presenting the plurality of non-text elements to the user comprises:
presenting the plurality of non-text elements to the user in accordance with an arrangement previously specified by the person authorized to control access to the resource.

10. A system for authenticating a user seeking to access a resource via a computer, comprising:
a database that stores a combination of non-text elements previously selected by a person authorized to control access to the resource; and
user authentication logic communicatively connected to the database, the user authentication logic configured to present a plurality of non-text elements to the user via a user interface of the computer, each of the plurality of non-text elements being selectable by the user via the user interface, to compare a combination of non-text elements selected by the user from among the plurality of non-text elements to the combination of non-text elements stored in the database, and to grant the user access to the resource via the computer responsive to determining that the combination of non-text elements selected by the user matches the combination of non-text elements stored in the database.

11. The system of claim 10, wherein the user authentication logic is configured to present a plurality of unique images to the user via a graphical user interface of the computer.

12. The system of claim 10, wherein the user authentication logic is further configured to determine an amount of time that has elapsed after presentation of the plurality of non-text elements to the user during which the user has not selected a combination of non-text elements and to send a message to the person authorized to control access to the resource if the amount of time exceeds a predefined amount of time.

13. The system of claim 12, wherein the user authentication logic is configured to send the message to a mobile device associated with the person authorized to control access to the resource.

14. The system of claim 10, wherein the user authentication logic is further configured to deny the user access to the resource responsive to a determination that the combination of non-text elements selected by the user does not match the combination of non-text elements stored in the database.

15. The system of claim 10, wherein the user authentication logic is further configured to prohibit any computer-based access to the resource responsive to a determination that the combination of non-text elements selected by the user is the second of two combinations of non-text elements selected by the user from among the plurality of non-text elements, each of which does not match the combination of non-text elements previously selected by the person authorized to control access to the resource.

16. The system of claim 10, wherein the user authentication logic comprises second-level user authentication logic and wherein the system further comprises:
first-level user authentication logic configured to execute a first-level user authentication process;
wherein the second-level user authorization logic is configured to operate responsive to successful completion of the first-level user authentication process by the user.

17. The system of claim 10, further comprising:
user account setup logic configured to allow the person authorized to control access to the resource to select the plurality of non-text elements to be presented to the user by the user authentication logic from a larger plurality of non-text elements.

18. The system of claim 17, wherein the user account setup logic is further configured to allow the person authorized to control access to the resource to specify an arrangement in which the plurality of non-text elements will be presented to the user by the user authorization logic; and
wherein the user authentication logic is further configured to present the plurality of non-text elements to the user in accordance with the specified arrangement.

19. A computer program product comprising a computer-readable medium having computer program logic recorded thereon for enabling a processing unit to authenticate a user seeking to access a resource via a computer, comprising:
first means for enabling the processing unit to present a plurality of non-text elements to the user via a user interface of the computer, each of the plurality of non-text elements being selectable by the user via the user interface;
second means for enabling the processing unit to compare a combination of non-text elements selected by the user from among the plurality of non-text elements to a combination of non-text elements previously selected by a person authorized to control access to the resource; and
third means for enabling the processing unit to grant the user access to the resource via the computer responsive to determining that the combination of non-text elements selected by the user matches the combination of non-text elements previously selected by the person authorized to control access to the resource.

20. The computer program product of claim 19, wherein the first means comprises means for enabling the processing unit to present a plurality of unique images to the user via a graphical user interface of the computer.
